(19) United States
(12) Patent Application Publication
(10) Pub. No.: US 2005/0113060 A1
(43) Pub. Date: May 26, 2005

(54) Wireless network system

(76) Inventor: Kenneth E. Lowery, Memphis, TN (US)

Correspondence Address: LUEDEKA, NEELY & GRAHAM, P.C., P O BOX 1871, KNOXVILLE, TN, 37901, US

(21) Appl. No.: 10/967,631

(22) Filed: Oct. 15, 2004

Related U.S. Application Data
(60) Provisional application No. 60/512,359, filed on Oct. 17, 2003.

(51) Int. Cl. H04M 9/00

(52) U.S. Cl. 455/402

(57) ABSTRACT

A wireless network system that facilitates locating and powering a plurality of wireless remote transceivers by incorporating the transceivers into a pre-existing infrastructure, such as electrical power lines so that costs associated with locating and providing power sources for the remote transceivers is reduced.

### RELATED APPLICATIONS

This is a utility patent application claiming priority to Provisional Application Ser. No. 60/512,359 filed Oct. 17, 2003, the teachings of which are incorporated herein.

### TECHNICAL FIELD

This invention relates generally to wireless networks. More particularly, the invention relates to a wireless network system that incorporates pre-existing infrastructure systems, such as electrical power lines, to support and power a plurality of wireless remote transceivers.

### BACKGROUND AND SUMMARY

Wireless networks are used to communicatively couple a wide variety of electronic devices such as cellular telephones, computers, and many other electronic devices, such that such devices may communicate with one another over a distance without having to be directly wired to one another. Wireless network systems typically include a large number of wireless remote transceivers located so as to enable wireless communication between proximate ones of the transceivers and between such transceivers and the electronic devices they are linking. For example, cellular telephone networks utilize a plurality of remote transceivers or “cells.” As a cellular telephone is traveled between cells, the telephone is “handed-off” from one cell to another located along the route. If the telephone is too far from a cell, service will be lost. Each cell is a relatively expensive tower structure requiring a power source. Accordingly, providing a wireless network system over a relatively extensive geographic area involves considerable expense and equipment, particularly in terms of locating and powering the numerous wireless remote transceivers needed to provide a network spanning a relatively large geographic area.

The present invention relates to a wireless network system that facilitates locating and powering a plurality of wireless remote transceivers by incorporating the transceivers into a pre-existing infrastructure, such as electrical power lines. The power line infrastructure is utilized to locate and power the remote transceivers so that costs associated with locating and providing power sources for the remote transceivers is reduced.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a representational view of a wireless network in accordance with a preferred embodiment of the invention.

FIG. 2 is a detailed view showing location of wireless remote transceivers on a pre-existing power line infrastructure.

FIG. 3 is a close-up view of a preferred wireless remote transceiver mounted on a power line according to the invention.

FIG. 4 is an end view showing the hinged construction of the transceiver of FIG. 3.

FIG. 5 is a detailed view showing components of the transceiver of FIG. 3.

FIG. 6 shows an alternate embodiment of a transceiver for use in the system of the invention.

### DETAILED DESCRIPTION

The present invention relates to a wireless network system that incorporates pre-existing infrastructure systems, such as electrical power lines, to support and power a plurality of wireless remote transceivers. Utility company power lines provide ready made support structures and power sources. This significantly reduces costs and labor associated with conventional network systems.

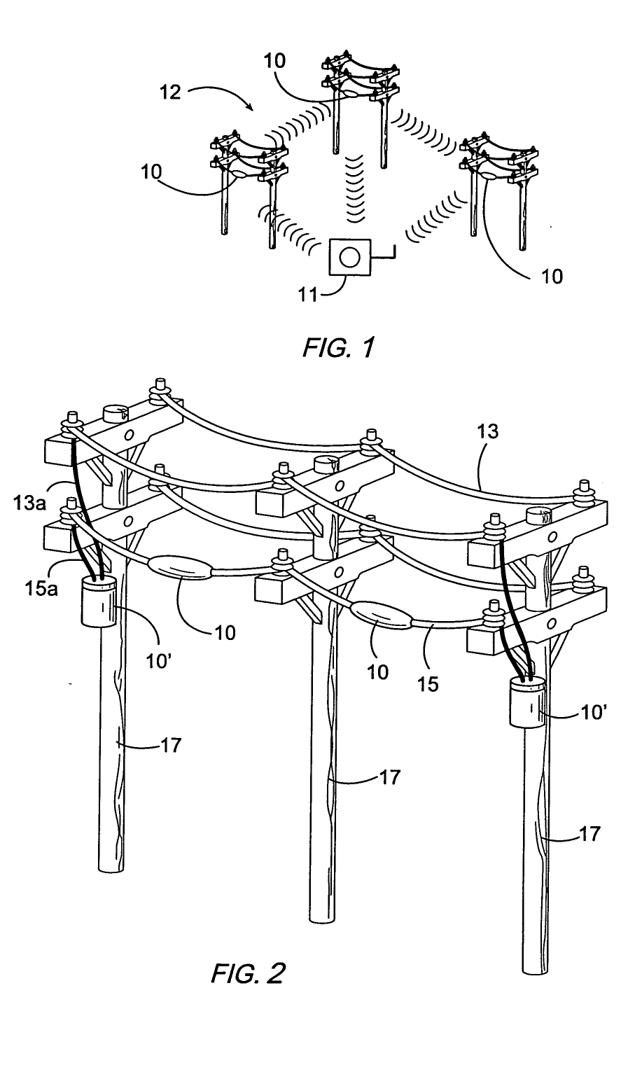

Referring now to FIG. 1, there is shown a drawing of a preferred embodiment of a wireless network 12 according to the present invention. The wireless network 12 employs a plurality of wireless remote transceivers, such as network modules 10, incorporated into a pre-existing power line infrastructure to provide high frequency radio links. These network modules 10 are fixed access points with which wireless applications, such as computers with wireless interfaces or other wireless devices, may connect to a wired local area network (LAN). The network modules 10 are located throughout a service area, such that a mobile wireless device traveling through the service area will constantly be in range of at least one network module. The network modules 10 are bridged together to create a wireless backbone of the wireless network 12, with the plurality of access points exchanging network traffic with each other and with a central network hub 11, which is connected to a wired LAN. In an alternate embodiment, the network modules 10 and a central network hub 11 may be bridged together by wired communication.

As an example, automobiles often contain a plurality of mobile wireless devices and wired computing devices that may be linked to the network. A network module in the service area may transmit information to the automobile's devices, such as navigational information, traffic and weather information, or allow communication with other wireless devices. However, as the automobile travels through a service area it will quickly reach the limits of the range of a network module. Once the automobile reaches a certain range from a network module, the wireless network will hand it off to a module within closer range of the vehicle. Therefore, an automobile traveling through the service area will constantly be in communication with at least one network module. When communication is interrupted, the network and device will buffer and store data until communication can be re-established.

FIG. 2 shows the modules 10 connected to power lines 13 and 15, which are supported by poles 17. As explained in more detail below, the modules 10 include an induction coil for receiving electrical power from the power line 15 for operation. In an alternate embodiment, the modules 10′ are attached to the poles 17. The modules 10′ may also include an induction coil, but may also be hard-wired to the lines 13 and 15 to receive electrical power for operation.

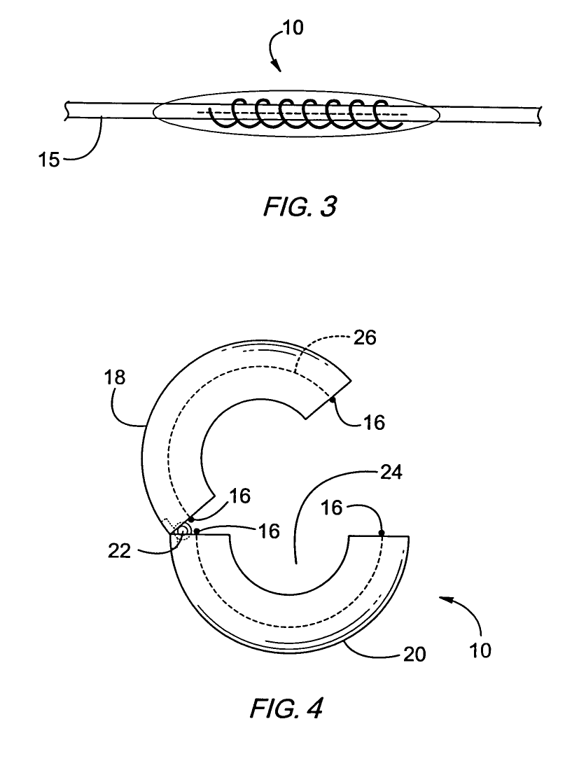

Referring now to FIGS. 3-5, each module 10 preferably includes a low profile aerodynamic cylindrical housing 14 disposed on a conductor, which is preferably one of the power lines 13 or 15. The network module 10 includes two sections, preferably a first half 18 and a second half 20, the two halves divided along the central axis of the cylindrical housing 14. The first half 18 and the second half 20 are joined by a hinge 22, which allows the halves to be clamped together onto a power line 15. The clamped power line 15 extends through an aperture 24 located along the central axis of the clamped cylindrical housing 14. This clamping configuration allows for quick and easy installation of the network modules 10 in the service area. An individual may simply choose any desired location on a power line and, using a bucket truck or other means, clamp the module 10 onto the power line, with no further installation needed.

In an alternative embodiment, the network module 10′ may be attached to a power line pole or any other support structure. For example, the network modules 10′ may be attached to tall buildings in a service area where power lines are located underground. As seen in FIG. 6, the module 10′ is preferably substantially identical to the module 10, except that it includes the power supply wires 13a and 15a and is preferably configured for attachment, such as by use of fasteners, to the poles 17.

The conductor, such as the power line 15, provides a fixed support and also provides the primary power source for the network module 10. An induction coil 26 is located within the network module 10 and is located so as to be wrapped around the circumference of the power line 15 when the module 10 is installed. As a power transformer, the induction coil 26 obtains power for the network module from the alternating current of the power line 15. The induction coil 26 is divided into two segments, preferably a first half and a second half, which are separately located in the two segments of the network module 10, thereby allowing the module 10 to hinge and clamp on the power line 15. The module 10 is clamped onto the power line 15 and the turns of the individual coils mate by corresponding contacts 16 to form a complete induction coil.

Since the modules 10 are not directly connected to the power line 15. i.e., in the sense that they are not in hard-wired electrical communication with the power line, the network modules 10 may be installed while the power line 15 is energized, further allowing ease of installation. This power configuration has a lower risk of power surges and line noise than a directly connected network module 10.

In alternative embodiments, the network module 10′ may use other primary sources of power, including direct connection to the power lines 13 and 15 as by wiring 13a and 15a. It will further be appreciated that other pre-existing power sources may be utilized, such as solar panels and the like.

An internal backup battery 28 is preferably located within the network module 10 to provide power when the power line 15 is not energized. When the power line 15 is energized the backup battery 28 is charged from the primary power source.

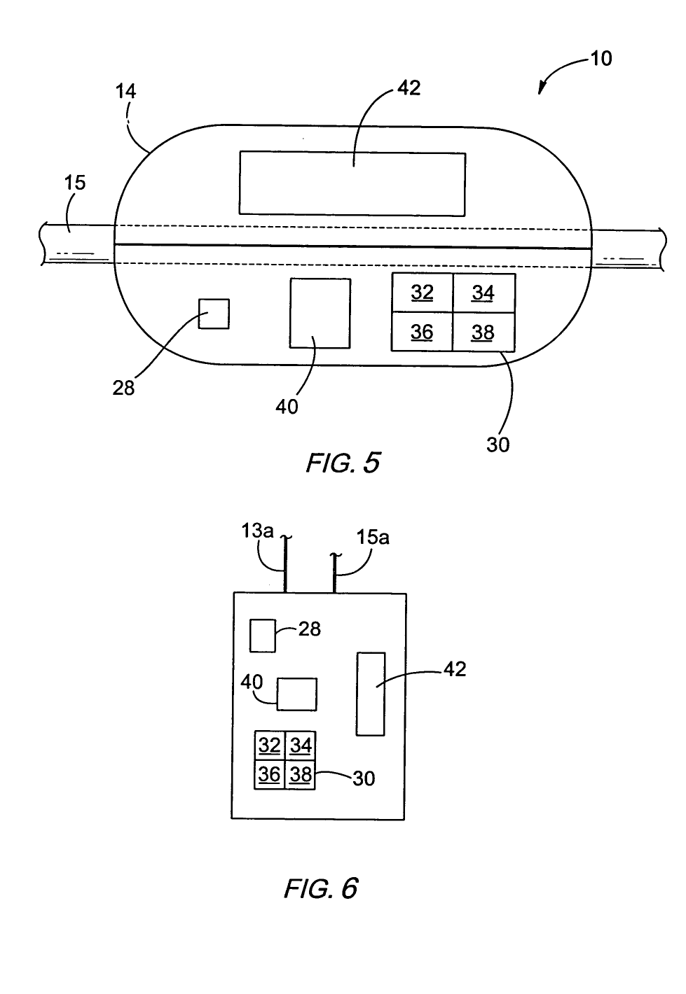

Referring to FIG. 5, there is shown a schematic drawing of a preferred communication device 30 located within the network module 10. Preferably, the communication device 30 for each network module 10 includes a plurality of radio units, such as access point radio 32, backbone receive radio 34, and backbone send radio 36.

The access point radio 32 provides network access to wireless applications within the service area. The access points are preferably spaced closely enough to provide sufficient, uninterrupted service without interference between the modules 10 closest to each other. An 802.11a standard radio, which operates at 5 GHz, is preferred, since it allows network modules to be placed in close proximity to each other with reduced interference due to the availability of twelve separate non-overlapping channels. The access point radio 32 may use other 802.11 standards.

The backbone receive radio 34 and the backbone send radio 36 are used for backbone communication for the network 12. The backbone radios 34, 36 preferably use the 802.11 g standard operating at 2.4 GHz. The backbone radios operate on different channels so the transmitted signal does not interfere with incoming signals. If interference is a problem due to line of sight, crowded networks, or for other reasons, 802.11a radios may be used for its increased number of channels. In an alternative embodiment, a single backbone radio may be used. In other embodiments the network module may not rely on radios for backbone communication, but may rely on other communication techniques such as power line carrier technology or the network module 10 may be directly connected to a wired LAN. A radio 38 utilizing Bluetooth technology may also be included to work with existing wireless technology in a service area.

The backbone communication is preferably controlled by the integrated circuit board 40, which contains routing and control software. Also, a variety of sensors may be coupled to the network module to further exploit the advantages of the wireless network. Preferably, a sensor array 42 is integrated into the network module 10. Alternatively, sensors may be located external to the network module 10 and may communicate with the network module 10 using Bluetooth, 802.11, wires, or other communication methods.

The sensor array 42 preferably contains a plurality of sensors. It will be appreciated that some sensors may be present in all network modules, while others may be in a particular number of network modules or based on the modules location. For example, weather sensors may be employed in the sensor array 4, such sensors preferably including temperature sensors, precipitation sensors, and wind speed sensors. These sensors may be used to monitor and predict weather conditions and may be used by utility companies to determine where power line breaks may occur. Further, strain gauges could be used to measure stress on power lines to help determine where breaks are eminent.

Audio transducers may also be included in the network modules 10 or 10′. Multiple network modules with audio transducers may be used to triangulate sounds, such as gun shots. Further, the audio transducers may be used as eavesdropping devices. The audio transducers may activate on triggers, such as human voices, gunshots, or explosions.

Video cameras may be employed in the sensor array 42. These cameras may be image capturing devices or full motion video cameras coupled with compression devices for transmission. Further, the cameras may utilize infrared detection or photomultiplier night vision. Image recognition algorithms may be utilized to identify threats, track vehicles, recognize people, or other purposes. The sensor array 42 provides improved visibility over a ground based system, capable of viewing a wide area from the suspended position.

Other sensors may be included in the sensor array 42 as needed. For example, radiation and chemical sensors may be utilized as an early warning system against possible attacks. Since the sensor array 42 is suspended above the ground, airborne threats are more easily detectable.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

1. A wireless network system for wirelessly interconnecting a plurality of devices, comprising a power line system and a plurality of wireless remote transceivers supportably positioned on the power lines and configured to receive electrical power for operation from the power lines, wherein the wireless remote transceivers communicate with each other to form the wireless network and communicate wirelessly with the plurality of devices to transmit data between said devices.

2. The wireless network system of claim 1, wherein the power line system comprises pre-existing power line infrastructure.

3. The wireless network system of claim 1, wherein the plurality of wireless remote transceivers comprise induction coils for receiving electrical power from the power lines and the power lines comprise conductors.

4. The wireless network system of claim 1, wherein the plurality of wireless transceivers comprise fixed access points through which wireless devices may connect to an internet hub.

5. The wireless network system of claim 1, wherein the plurality of wireless remote transceivers comprise a first half and a second half which are joined by a hinge, such that the halves may be clamped together on the power line.

6. The wireless network system of claim 1, wherein the plurality of wireless remote transceivers comprise cellular communication devices.

7. The wireless network system of claim 1, wherein the plurality of wireless remote transceivers comprise radio communication devices.

8. The wireless network system of claim 1, wherein the plurality of devices comprise computers.

9. The wireless network system of claim 1, wherein the plurality of wireless remote transceivers are in a wired relationship with the power lines.

10. The wireless network system of claim 1, wherein the plurality of wireless remote transceivers wirelessly communicate with a central network hub.

11. The wireless network system of claim 1, wherein the plurality of wireless remote transceivers comprise sensors.

12. The wireless network system of claim 1, wherein the sensors comprise at least one of weather sensors, strain gauges, audio sensors, visual sensors, radiation sensors, and chemical sensors.

13. A suspended sensor array, comprising a power line system, a plurality of sensors, and a plurality of wireless remote transceivers, the plurality of wireless remote transceivers and the plurality of sensors supportably positioned on the power line system and configured to receive electrical power for operation from the power line.

14. The suspended sensor array of claim 12, wherein the plurality of wireless remote transceivers and the plurality of sensors are supportably positioned on the power lines.

15. The suspended sensor array of claim 12, wherein the plurality of wireless remote transceivers comprise induction coils for receiving electrical power from the power lines.

16. The suspended sensor array of claim 12, wherein the plurality of sensors comprise at least one of weather sensors, strain gauges, audio sensors, visual sensors, radiation sensors, and chemical sensors.

17. The suspended sensor array of claim 12, wherein the plurality of wireless remote transceivers are in wireless communication with a central network hub.

18. The suspended sensor array of claim 12, wherein the plurality of wireless remote transceivers comprise a first half and a second half which are joined by a hinge, such that the halves may be clamped together on the power line.

19. The suspended sensor array of claim 12, wherein the plurality of wireless remote transceivers are mounted on power line support poles.

20. A wireless network system comprising:
a power line system;
a plurality of wireless remote transceivers for wirelessly connecting a plurality of wireless devices, wherein the plurality of wireless remote transceivers are supportably positioned on the power lines and comprise induction coils for receiving power from the power lines; and
a sensor array for collecting information, the sensor array comprising at least one sensor in communication with the wireless remote transceivers, such that the wireless remote transceivers transmit the collected information to a central hub.
